(19) United States
(12) Patent Application Publication
(10) Pub. No.: US 2007/0056008 A1
(43) Pub. Date: Mar. 8, 2007

(54) Updating system of music database, transmission apparatus of music database, terminal having update function of music database, updating method of music database, transmission method of music database, and updating method of music database in terminal

(76) Inventors: Satoru Nagamoto, Hyogo (JP); Takao Yamaguchi, Hyogo (JP); Ikuo Ohta, Tokyo (JP); Naruhiko Nihira, Tokyo (JP); Shoichi Izaki, Tokyo (JP); Takahito Iida, Tokyo (JP)

Correspondence Address: FOGG AND ASSOCIATES, LLC, P.O. BOX 581339, MINNEAPOLIS, MN, 55458-1339, US

(21) Appl. No.: 10/569,541

(22) PCT Filed: Aug. 25, 2004
(86) PCT No.: PCT/JP04/12607

§ 371 Date: Nov. 3, 2006

(30) Foreign Application Priority Data
Aug. 25, 2003 (JP) 2003-300301

(51) Int. Cl. H04N 7/173; H04N 7/16

(52) U.S. Cl. 725/115; 725/144; 725/145; 725/131; 725/151

(57) ABSTRACT

An updating system able to easily and cheaply update the content of a music database in a terminal having a music database, including (i) a transmission apparatus 20 including a transmission use music database 21 for storing music database information comprised of identification information and corresponding music information and a broadcast function unit 23 for broadcasting the music database information from the database 21 multiplexed on a broadcast wave and (ii) a terminal 30 including a reception function unit 33 for receiving the broadcast wave from the broadcast function unit 23, an extraction function unit 34 for extracting the music database information from the received broadcast wave, and an update function unit 32 for storing the extracted music database information in the reception side music database.

### TECHNICAL FIELD

The present invention relates to an updating system of a music database, a transmission apparatus of a music database, a terminal having an update function of a music database, an updating method of a music database, a transmission method of a music database, and an updating method of a music database in a terminal.

### BACKGROUND ART

Development of terminals, particularly terminals to be mounted in automobiles, has been remarkable. The terminals are becoming increasingly higher in performance along with the increasing sophistication of network communications. For example, high performance automobile mounted terminals equipped with audio and visual functions such as navigation and CD, MD, DVD, MP3, and other music files, broadcast reception functions such as TV, FM•AM/FM multiplex/FM-VICS, and sound field and tone adjustment functions such as DSP and equalizers are already commercially available.

The present invention is aimed at for example the terminals as described above and among them especially notes the “audio and visual functions” among the above various types of optional functions.

The “audio and visual functions” are realized linked with a memory built into the terminal (such as a HDD (hard disk drive)). A “music database” can be previously recorded in this memory.

FIG. 11 is a diagram for explaining the music database covered by the present invention.

In the figure, only a recording medium (for example a CD) 1, a display unit 2, and a memory (for example HDD) 3 in a terminal 30 are taken out and diagrammatically drawn.

This memory 3, for example, stores a music database of approximately 230,000 tracks. This music database includes identifying information of the recording media (for example Table of Contents (TOC)) and music menu information corresponding to the identifying information such as the album names, track names, artist names, and genres. Accordingly, the terminal 30 realizes a so-called auto titling function using this music database.

Namely, in the terminal 30, the music database information is automatically recorded when recording music of a music recording medium (for example CD) in the memory 3. For this reason, the convenience of enabling the content of the music library to be prepared in the memory 3 without requiring troublesome title input can be provided to the user of the terminal 30.

[1], [2], and [3] in the figure represent an example of the process of the above auto titling function in three steps.

In [1], when the recording medium 1 which the user desires to record is inserted into slot (not illustrated) of the terminal 30,

in [2], on the basis of the identifying information stored in the recording medium 1, for example, the TOC (Table Of Contents) information, the music menu information is searched for from the above music database in the memory 3. Note that this TOC information usually includes the total performance time, the number of recorded tracks, and their recorded positions.

In [3], when the search turns up music information matching the identifying information, the title name is extracted from that and that title name added to the track data recorded from the recording media 1 in the above [1]. This completes the auto titling process.

In this way, the terminal 30 can also provide the service of freedom from troublesome title input. However, there is also an inconvenient point. This is the point that the track database cannot be updated after the terminal 30 is mounted in a vehicle. That is, the titles for recording media of new music subsequently released cannot be input. Alternatively, the titles of recording media of revivals which become popular thereafter cannot be input.

Accordingly, a user of this terminal would find it extremely convenient if subsequent addition to or other updating of music database could be simply and easily carried out.

A conventional technique which can deal with this will be explained below.

FIG. 12 is a diagram showing a conventional method for updating a music database (first example).

According to the updating method according to this conventional first example,

[1] the user of the terminal 30 accesses a music database update site 5 on the Internet from his personal computer 6.

[2] On the site 5, the user extracts parts of the title database which he has not yet acquired, that is, the difference from his already acquired title database, and downloads the extracted difference in title database to his personal computer 6.

[3] The user transfers the difference in title database downloaded into the personal computer 6 to a carrying medium 7. The user brings the carrying medium 7 to the terminal 30 and installs the difference in title database into the memory 3. This carrying medium 7 is for example a Memory Stick®.

Here, the titles of new recording media such as new music are recorded in the memory 3 for updating.

According to the updating technique according to a conventional second example, the user directly connects to a center managing the music database by a communication function unit and acquires the difference in title database. This communication function unit is for example a mobile phone directly connected to the terminal 30.

Note that, as known art relating to the present invention, there are the following Patent Documents 1 and 2. However, as will be apparent from the explanation given later, both known arts are different from the music database updating system of the present invention comprising

“a transmission apparatus having a transmission use music database storing music database information comprising identification information for identifying recording media and music information corresponding to that identification information and a broadcast function unit for broadcasting said music database information from said transmission use music database multiplexed on a broadcast wave and

a terminal including a reception function unit for receiving the broadcast wave on which the music database information broadcast from the broadcast function unit is multiplexed, an extraction function unit for extracting the music database information from the broadcast wave received by the reception function unit, and an update function unit for storing the music database information extracted by the extraction function unit in the reception side music database”.

Note that the system according to Patent Document 1 uses a tuner receiving an FM multiplexed broadcast to demodulate the information concerning the music distribution from an FM signal and transmit the data to the HDD recorder equipped with a communication function. This HDD recorder equipped with a communication function activates software connected to the network on the basis of the data and connects to the URL of a download server distributing the music data included in the data. Due to this, the system receives the download of the music data.

Also, the apparatus of Patent Document 2 is an automobile mounted information terminal for receiving broadcasts of text information transmitted from an information center such as event information concerning events held at amusement facilities and specific areas and information changing day by day such as weather forecasts.

[Patent Document 1] Japanese Patent Publication (A) No. 2001-298430

[Patent Document 2] Japanese Patent Publication (A) No. 11-30524

### DISCLOSURE OF THE INVENTION

Problem to be Solved by the Invention

According to the updating technique according to the conventional first example (FIG. 12), there is the problem that the demand from the user of “simply and easily” mentioned before cannot be satisfied.

Also, according to the updating technique according to the conventional second example (direct communication), there is the problem that the demand from the user of “easily and cheaply” mentioned before cannot be satisfied.

This is because, according to the updating technique according to the conventional first example,

a personal computer 6 and Internet environment and a Memory Stick® or other carrying medium 7 are necessary,

the user must download the data from the recording medium music database update site 5 by himself, and

also, the trouble of updating the terminal 30 by using the carrying medium 7 becomes necessary.

Also, according to the updating technique according to the conventional second example,

the trouble of using a mobile phone from the vehicle mounting the terminal 30 to connect the terminal 30 to a center managing the music database is necessary, and

a communication fee for downloading the data from the center becomes necessary.

Accordingly, in consideration of the above problems, an object of the present invention is to provide a music database updating system enabling updating simply and easily and in addition cheaply when it is necessary to update the music database in a terminal storing the music database due to for example the release of recording media of new music (for example CDs).

Means for Solving the Problems

FIG. 1 is a view of the basic configuration of an updating system of music database according to the present invention.

In the figure, reference numeral 10 is an updating system of a music database roughly comprised of a transmission apparatus 20 and a terminal 30 (FIG. 11 and FIG. 12).

The transmission apparatus 20 is configured by a transmission use music database (DB) 21 for storing music database information comprised of identification information for identifying recording media and music information corresponding to that identification information and a broadcast function unit 22 for broadcasting said music database information from said transmission use music database multiplexed, as multiplexed information, on a predetermined broadcast wave.

On the other hand, the terminal 30 is comprised of a reception function unit 33 for receiving a predetermined broadcast wave on which the music database information broadcast from the broadcast function unit is multiplexed, an extraction function unit 34 for extracting the music database information from the predetermined broadcast wave received by the reception function unit 33, and an update function unit 32 for storing the music database information extracted by the extraction function unit 34 in the reception side music database 31.

In this way, the updating system 10 of the present invention utilizes the general infrastructure constituted by a broadcast wave (for example, an FM broadcast) to distribute the music database information multiplexed on the broadcast wave and further update the reception side music database.

For this reason, the side providing the music database (transmission apparatus 20 side) needs the function of transmitting the music database information as multiplex information multiplexed on a predetermined broadcast wave.

Also, the user side (terminal 30 side) needs a function of receiving a multiplexed broadcast wave, for example, an FM multiplexed broadcast wave, a function of extracting the music database information from the received multiplexed broadcast wave, and a function of recording the extracted music database in the reception side music database 31.

By providing the above functions, the following characteristic features are obtained at the user side (terminal 30 side), the side providing the music database (transmission apparatus 20 side), and the user himself.

First, on the user side (terminal 30 side),

so long as a conventional multiplexed broadcast wave can be received, no special hardware is necessary.

acquisition and addition of album units of the music database are possible, therefore it is not necessary to continuously receive the broadcast wave for a long time.

Next, on the side providing the music database (transmission apparatus 20 side),

no dedicated infrastructure need be prepared, so a new capital investment is unnecessary.

By extraction from the music database information under any conditions, distribution of database information specific to each broadcasting station becomes possible. Further, distribution is possible even for recording media not yet put on sale so long as a music database is available.

By setting the database information in units of album, the load of the broadcasting station may be reduced.

Further, when viewing the user himself,

it becomes possible to simply, easily, and cheaply add new information to the music database.

The database can be acquired by just receiving the broadcast, so no special operation etc. are necessary.

The transmission medium is the general infrastructure constituted by a broadcast, therefore no communication cost is required for acquiring the music database and also a database recording medium such as the Memory Stick® mentioned above becomes unnecessary.

Thus, all users owning the terminals 30 shown in FIG. 1 become able to update their reception side music databases 31 simply and easily and in addition cheaply.

### EFFECTS OF THE INVENTION

As clear from the above, according to the present invention, a music database in a terminal 30 can be simply and easily and further freely updated. Further, the updating can be completed before the release of new music.

### BRIEF DESCRIPTION OF THE DRAWINGS

FIG. 1 is a view of the basic configuration of an updating system of a music database according to the present invention.

FIG. 2 is a diagram more specifically showing a transmission apparatus 20 shown in FIG. 1.

FIG. 3 is a diagram more specifically showing a terminal 30 shown in FIG. 1.

FIG. 4 is a diagram showing a more specific overall configuration of an updating system 10 according to the present invention.

FIG. 5 is a diagram of the system configuration shown more specifically than FIG. 4.

FIG. 6 is a view of an example of the hardware configuration of the transmission apparatus 20.

FIG. 7 is a view of an example of the hardware configuration of the terminal 30.

FIG. 8 is a flow chart of an example of operation of the updating system (part 1).

FIG. 9 is a flow chart of an example of operation of the updating system (part 2).

FIG. 10 is a flow chart of an example of operation of the updating system (part 3).

FIG. 11 is a diagram for explaining the music database covered by the present invention.

FIG. 12 is a diagram showing a conventional updating method of a music database (first example).

### BEST MODE FOR CARRYING OUT THE INVENTION

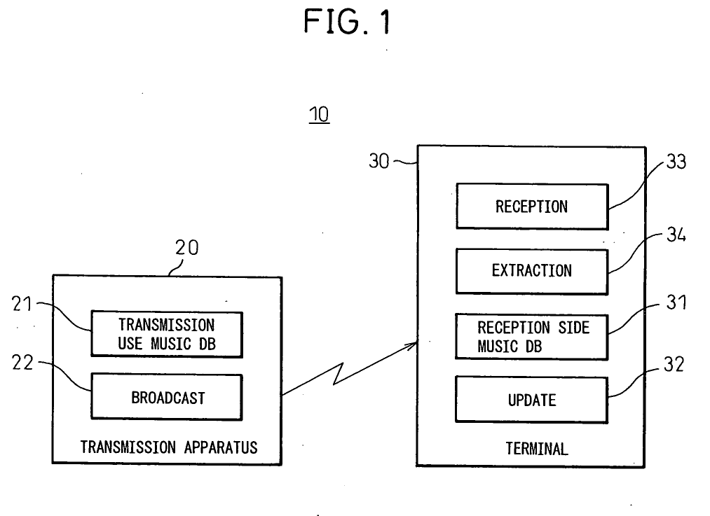

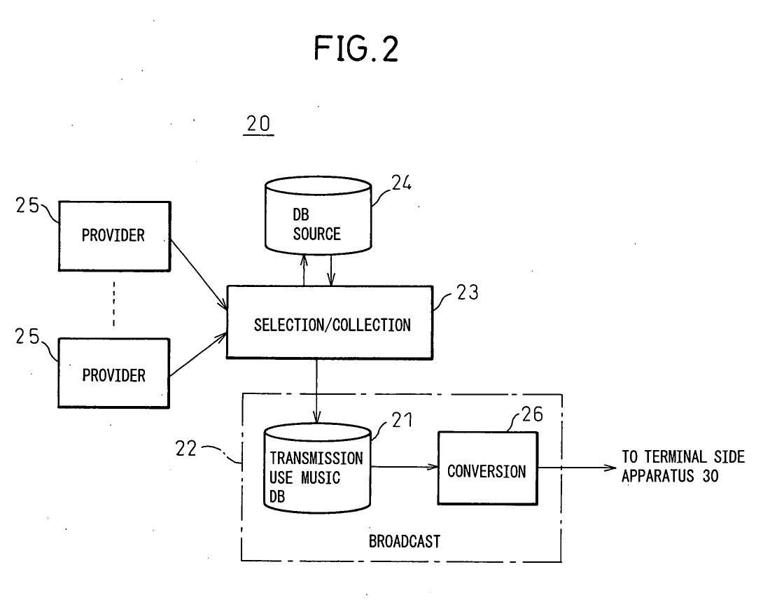

FIG. 2 is a diagram more specifically showing the transmission apparatus 20 shown in FIG. 1.

In the figure, reference numeral 23 is a selection/collection function unit.

The selection/collection function unit 23 connects to a transmission use music database 21 and selects and collects the music database information to be stored in the database.

As a first example, the selection/collection function unit 23 selects music database information to be collected based on various popularity ranking information from various music providers 25.

As a second example, the selection/collection function unit 23 selects the music database information to be collected based on the frequency of broadcasts at various music providers 25.

As a third example, the selection/collection function unit 23 selects the music database information to be collected based on power play information generated among cooperating music providers 25 or new music release information.

An important source of information for this selection/collection function unit 23 is a database (DB) source 24. That is, a database source 24 is provided for continuously editing and registering new music, and the selection/collection function unit 23 collects the music database information selected from the database source 24. Note that the transmission use music database 21 and the database source 24 may also be the same. The transmission use music database 21 may also store the collected music information database information without deletion.

Therefore, the music database information collected is stored in the transmission use music database 21, then the timing for transmission by the broadcast function unit 22 is awaited.

The broadcast function unit 22 multiplexes all of the music database information of the transmission use music database 21 or the difference of the music database information newly added and collected in the transmission use music database 21 on a predetermined broadcast wave, for example, an FM broadcast wave, and broadcasts it to the terminal 30.

As the timing for transmission at this time, the broadcast function unit 22 multiplexes the music database information on a predetermined broadcast wave for broadcast repeatedly at all times or periodically at predetermined times.

At the time of transmission, a predetermined transmission format is used. Therefore, the broadcast function unit 22 is preferably provided with a conversion function unit 26 for converting the music database information to be transmitted to a format for multiplexing on a predetermined broadcast wave.

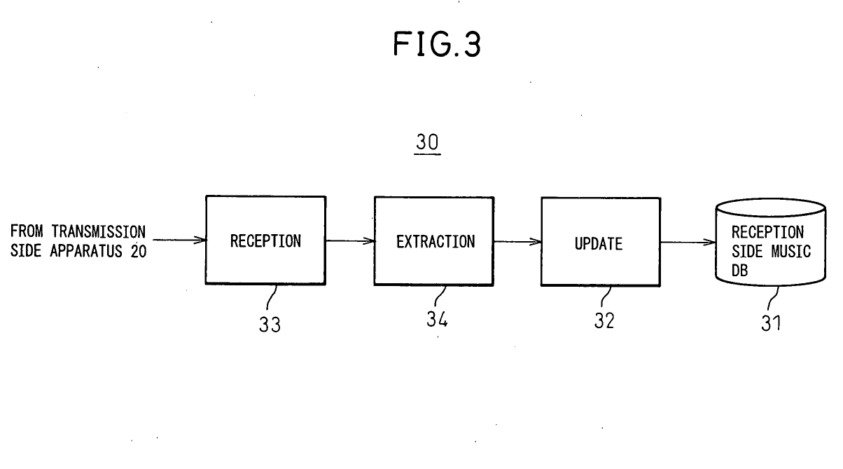

FIG. 3 is a view more specifically showing the terminal 30 shown in FIG. 1.

As explained above, a reception function unit 33 receives the multiplexed broadcast wave. An extraction function unit 34 extracts the music database information from the received multiplexed broadcast wave and outputs it to an update function unit 32.

The reception of this multiplexed broadcast wave should be limited to users authorized to receive the music database information service.

Therefore, the reception function unit 32 receives the multiplexed broadcast wave locked at the transmission apparatus 20 side, demodulates the music database information from the unlocked multiplexed broadcast wave, and outputs it to the extraction function unit 34. That is, a user not holding the key cannot receive the service. Note that the key may be set in advance in the terminal or may be set in the terminal after purchase of the key.

This service is a new service based on the present invention. Therefore, the transmission apparatus 20 side and the terminal 30 broadcast and receive information using a format agreed on between them.

Accordingly, the extraction function unit 34 has as one of its functions to pull out the music database information multiplexed on a predetermined broadcast wave by a predetermined format in accordance with that format.

The music database information pulled out is recorded by the update function unit 32 in the reception side music database 31. There are the following three patterns (i), (ii), and (iii) of updating information.

(i) When receiving all of the music database information from the transmission use music database 21 of the transmission apparatus 20 side, the update function unit 32 rewrites the reception side music database 31 with all that music database information received from the transmission use music database of the transmission apparatus side. Note that this update pattern cannot be applied to a case where the transmission side music base 21 stores only the difference of the music database information.

(ii) When receiving all of the music database information from the transmission side music database 21 on the transmission apparatus 20 side, the update function unit 32 finds the unrecorded music database information from it and stores this in the reception side music database 31 as the newly added difference in music database information.

(iii) When receiving the newly added and collected difference in music database information from the transmission use music database 21 of the transmission apparatus 20 side, the update function unit 32 adds and stores the difference in music database information in the reception side music database 31.

No matter which of the above three patterns (i) to (iii) is used, it is necessary to set at which timing to broadcast that music database information to the user. As typical examples, there are (i) the method of repeated broadcast at all times and (ii) the method of periodic broadcast at predetermined times. However, no matter which method is used for broadcasting, once the desired information is acquired, there is no need to obtain the same information again until new information is broadcast.

Therefore, the update function unit 32 acquires once the music database information or difference in music database information broadcast repeatedly at all times or periodically at predetermined times from the transmission apparatus 20 side, detects if the information is the same as the already received information, and, when not, stores it in the reception side music database 31.

Above, the present invention was explained from the viewpoint of the hardware configuration by referring to FIG. 1 to FIG. 3, but the present invention can also be understood as a novel method. An explanation will be given of this method below.

[A] The method according to the present invention is an updating method of a music database in an updating system 10 of a music database provided with a transmission apparatus 20 and a terminal 30, comprising, at the transmission apparatus 20,

Step S11: storing music database information comprised of identification information (TOC) for identifying the recording media (CD) and music information corresponding to the identification information in a transmission use music database,

Step S12: broadcasting the music database information of the transmission use music database 21 multiplexed as multiplex information on a predetermined broadcast wave, and

at the terminal 30,

Step S21: receiving the music database information from the transmission apparatus 20 and

Step S22: storing the received music database information in a reception side music database 31.

(a) Step S11 includes step S13 of selecting and collecting the music database information. The selection and collection at step S13 may be performed based on various popularity ranking information from various music providers 25.

Further, the selection and collection step S13 may be performed based on the frequency of broadcast at the various music providers 25.

Still further, the selection and collection step S13 may be performed based on power play information generated among cooperating music providers 25 or new music release information.

The selection and collection step S13 in this case is efficiently performed in cooperation with a database source 24 continuously editing and registering new music to build a general music database.

(b) The broadcast step S12 broadcasts all of the music database information of the transmission use music database 21 or the difference in music database information newly added in the transmission use music database 21 multiplexed as multiplex information on a predetermined broadcast wave.

The broadcast step S12 transmits the music database information repeatedly at all times or periodically at predetermined times multiplexed as multiplex information on a predetermined broadcast wave.

The broadcast step S12 preferably transmits the music database information to be transmitted converted to a format for a broadcast wave.

The method according to the present invention is an updating method of a music database in an updating system 10 of a music database provided with a transmission apparatus 20 and a terminal 30, comprising, at the terminal 30,

Step S31: receiving the music database information transmitted from the transmission apparatus 20 multiplexed on a predetermined broadcast wave and

Step S32: storing and updating the received music database information in a reception side music database 31 enabling searches of corresponding music information based on identification information (TOC) recorded in the recording media (CD) to be played.

(a) The updating step S32 preferably includes a step of extracting the music database information from the received predetermined broadcast wave.

(b) The receiving step S31 receives the multiplexed broadcast wave locked at the transmission apparatus 20 side and unlocks the multiplexed broadcast wave by a key held by the terminal 30 or receives the multiplexed broadcast wave including the music database information locked at the transmission apparatus 20 side and unlocks the music database information by a key held by the terminal 30 so as to demodulate the music database information.

(c) The receiving step S31 preferably includes a step of pulling out music database information multiplexed on a predetermined broadcast wave by a predetermined format in accordance with that format.

(d) The storing step S32 may rewrite the reception side music database 31 with all of the music data information from the transmission use music database 21 of the transmission apparatus 20 side when receiving that all music data information.

Alternatively, the storing step S32 may find the unrecorded music database information from all of the music database information received from the transmission use music database 21 of the transmission apparatus 20 side and store this in the reception side music database 31 as newly added difference in music database information.

Further, the storing step 32 may add and store the difference in music database information newly added from the transmission use music database 21 of the transmission apparatus 20 side in the reception side music database 31 when receiving that difference in music database information.

Whatever the case, in the storing step S32, it is preferable to once hold the music database information or difference in music database information transmitted from the transmission apparatus 20 side repeatedly at all times or periodically at predetermined times, detected if that information is the same as the already received information, and, if not, storing the information in the reception side music database 31.

Next, an updating system for a music database according to the present invention will be explained more specifically.

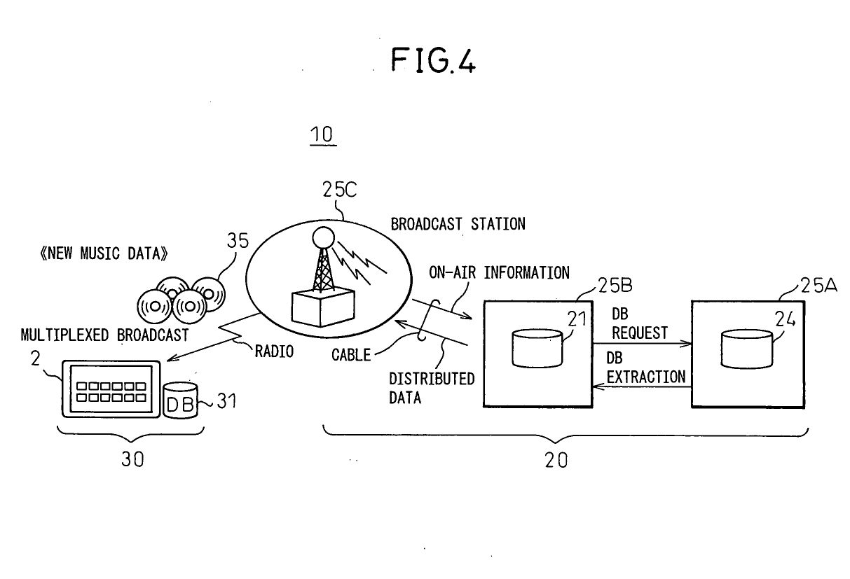

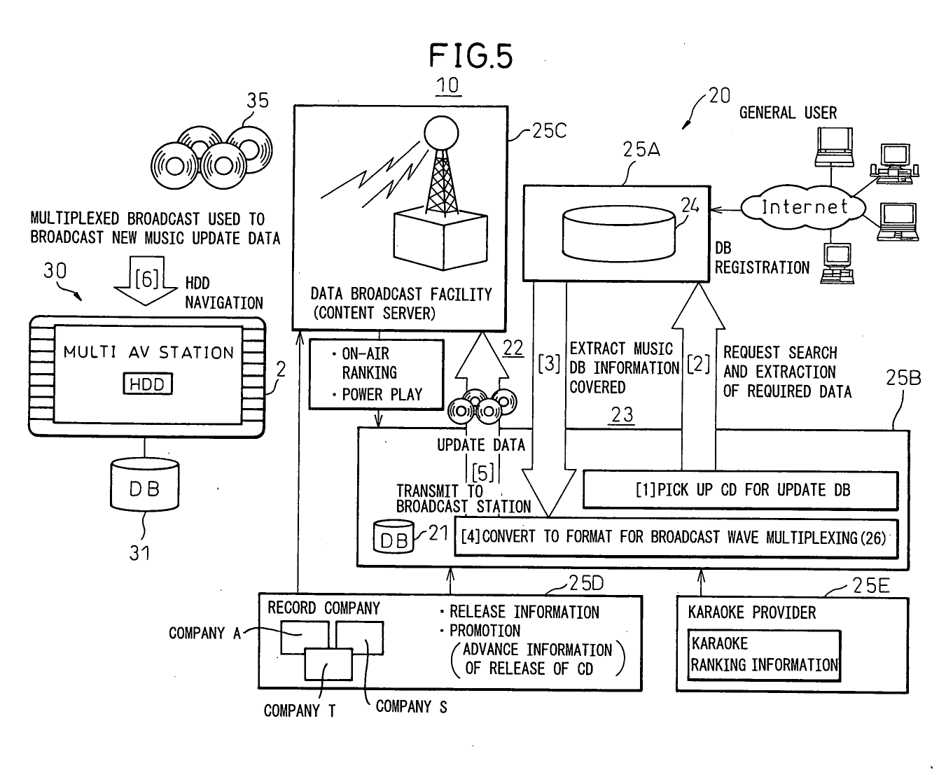

FIG. 4 is a diagram showing a more specific overall configuration of an updating system 10 according to the present invention.

The transmission apparatus 20 is comprised, in the present figure, by facilities and equipment owned by three music database information providers (25). A provider 25A manages the database source 24, a provider 25B manages the transmission use music database 21, and a provider 25C manages a broadcast facility.

The provider 25B selects the music to be updated based on the on-air information, requests the corresponding music database information from the provider 25A, cuts out the corresponding music database information, and stores the same in its own transmission use music database 21. Further, the music database information stored in the transmission use music database is forwarded to the provider 25C as the distribution data. Further, the provider 25C broadcasts the forwarded music database information to the terminal 30 side while multiplexing it on the broadcast wave. The terminal 30 receives this and stores this in its own reception side music database 31. The user can confirm the stored information at the display unit 2. Note that the patterns of the music database information stored in the transmission use music database 21 and the patterns of updating the reception side music database 31 of the terminal 30 were explained above, so explanations will be omitted.

Here, the on-air information of the provider 25A, the transmission side music database of the provider 25B, and the database source of the provider 25C are linked to realize a new service enabling data of new music to be distributed before release for sale.

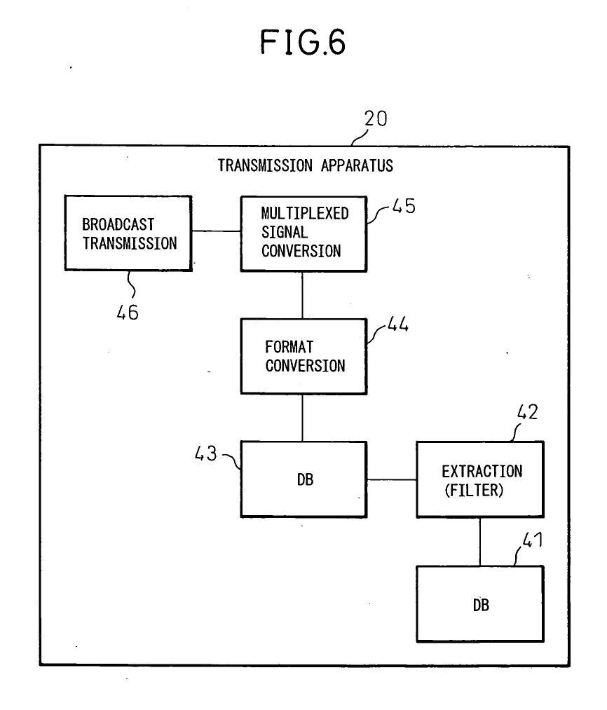

FIG. 5 is a diagram of the system configuration shown more specifically than FIG. 4.

The updating system 10 of the figure, like in FIG. 4, is comprised of a right side transmission apparatus 20 and a left side terminal 30. Note that compared to FIG. 4, a music database information provider (record company) 25D and a music database information provider (karaoke provider) 25E are added. Further, a general user internet is also added to the provider 25A on the right in the figure. Note that the music database information providers are not limited to these and may be any providers able to provide ranking information, information on the frequency of broadcasts, etc. such as cable broadcasters.

The broadcast function unit 22 and the selection/collection unit 23 explained above are indicated with reference numerals at their corresponding positions.

Further, [1] to [6] in the figure show the series of processes.

[1] The recording media for updating are selected. For this selection, new music release information from the provider 25D, popularity ranking information from the provider 25E, and popularity ranking information, broadcast frequency information, power play information, etc. from the provider 25C are referred to. The “power play information” is information determined by business discussions among cooperating providers.

[2] When the DB for updating is selected by the above [1], the necessary data is searched for and its extraction is requested to the provider 25A managing the database source 24. Note that the database source 24 is a general music database continuously editing and registering new music including database registration from general users.

[3] Therefore, the music database information covered is extracted and is stored in the transmission use music database 21. In the above, the processes [1] to [3] are executed by the selection/collection function unit 23. Note that the patterns of music database information stored in the transmission use music database 21 are explained above, so explanations are omitted.

[4] When the music database information to be updated is extracted by [1] to [3], the data showing that information is converted to a format for multiplexing on a broadcast wave. This conversion is performed by the conversion function unit 25 in the broadcast function unit 22 (FIG. 2). (This may be performed by either the provider 25B or 25C.)

[5] The music database information converted in that format is transmitted by the broadcast function unit 22 in the provider 25C, that is, the broadcast facility.

[6] The transmitted music database information is received by the terminal 30, and the content of the reception side music database 31 is automatically updated.

At the time of reception in this case, the above-mentioned key is used. Since the information is transmitted locked from the transmission apparatus 20 side, the key is used for restoration of the original information. The processing for locking and unlocking can be realized by scrambling and descrambling.

As explained above, according to the updating (distribution) system 10 shown in FIG. 5, a new entertainment service is realized utilizing the multiplexed broadcast receiver broadly mounted in car navigation/car audio systems. This does not require concern over communication costs or mounting of expensive communication devices. Further, this can be easily built into equipment. Therefore, this is an optimal new service for car-mounted terminals.

The characterizing features are listed below:

(a) It is possible to select recording media with a high user need from the information and possible to provide a user with new music before its date of release.

(b) It is possible to broadcast update data for a maximum of 50 titles of recording media every week. This is based on the following formula:

50 titles/week=200 music recording media released for sale/month/4 weeks

50 titles are repeatedly broadcast each day. Once starting to receive them, it is possible to obtain 50 titles worth of data in about 1 hour.

Therefore, the user side gains the following merits.

(a) Almost all recording media released each week can be obtained (assuming number distributed to be a maximum of 50 titles/week).

(b) Data on new music recording media can be obtained before the date of release.

(c) Since the general infrastructure as constituted by a broadcast wave is utilized, the communication cost is zero.

(d) So long as a broadcast can be received, the information can be automatically obtained, so there is no need for any user operation.

Finally, examples of the actual hardware configurations and examples of the actual operations of the transmission apparatus 20 and the terminal 30 will be shown.

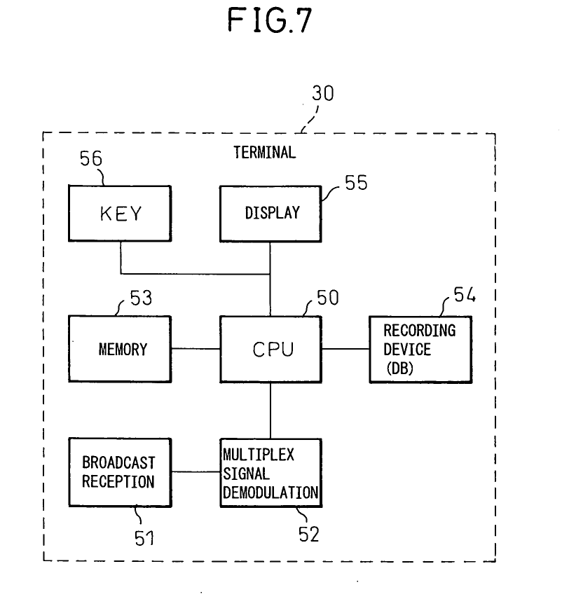

FIG. 6 is a view of an example of the hardware configuration of the transmission apparatus 20, while FIG. 7 is a view of an example of the hardware configuration of the terminal 30.

First, referring to FIG. 6, the database (DB) unit 41 corresponds to the database source 24 of FIG. 5. The extraction unit 42 extracts the database information covered along with the process [3] of FIG. 5 from the database (DB) unit 41.

The extracted database information is stored once in the database (DB) 21 managed by the provider 25B of FIG. 5 and is converted in format by the format converter 44 along the process [4] of FIG. 5.

Further, the broadcast facility of the provider 25C of FIG. 5 uses the multiplex signal converter 45 to convert the information to a multiplex signal and sends it by a broadcast transmitter 46 to the terminal 30.

Referring to FIG. 7, the terminal 30 receives the transmitted multiplex signal from the broadcast reception unit 51 and extracts the database information to be updated at the multiplex signal demodulater 52.

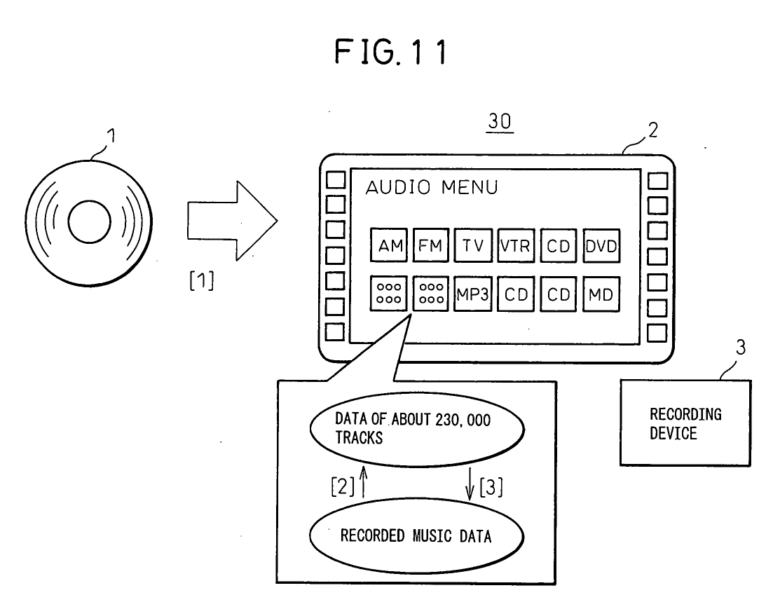

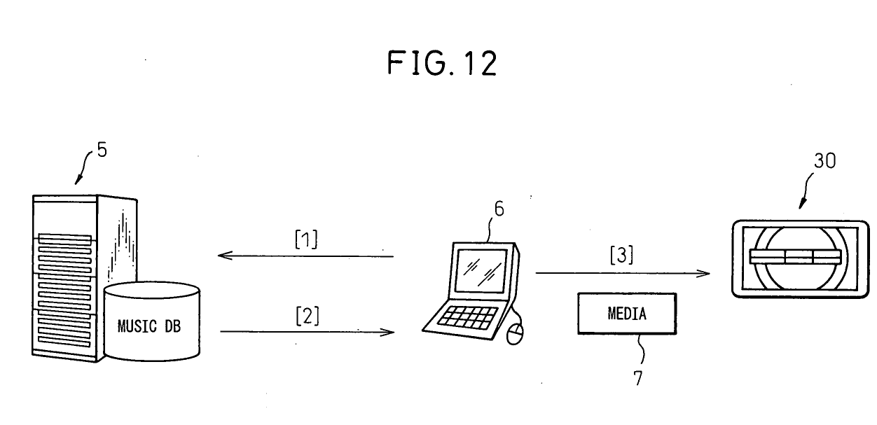

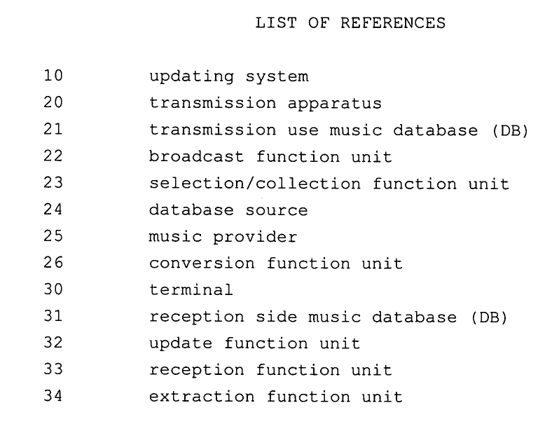

The updated database information is stored via the CPU 50 in a recording device 54 (3 in FIG. 11).

The CPU 50 cooperates with a memory 53 including a ROM and RAM and displays the music database information stored in a recording device 54 on a display 55 (2 in FIG. 11) in accordance with a user instruction from a keyboard (KEY) 56.

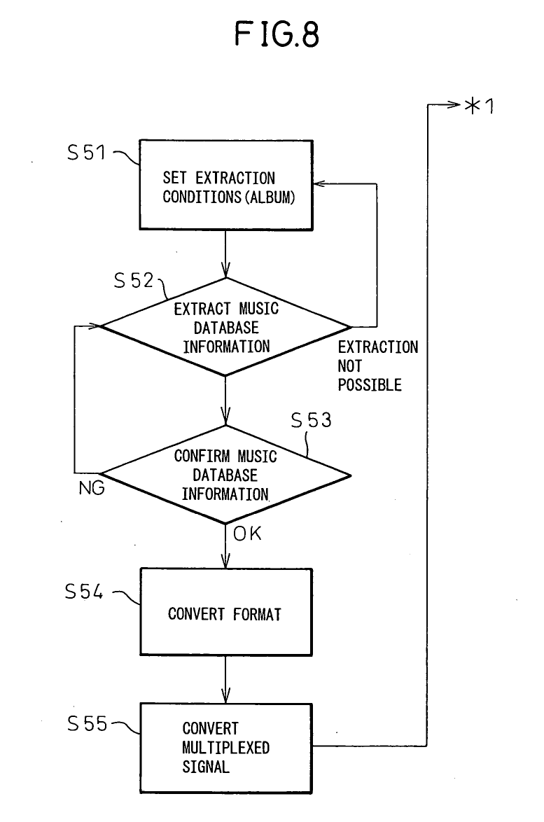

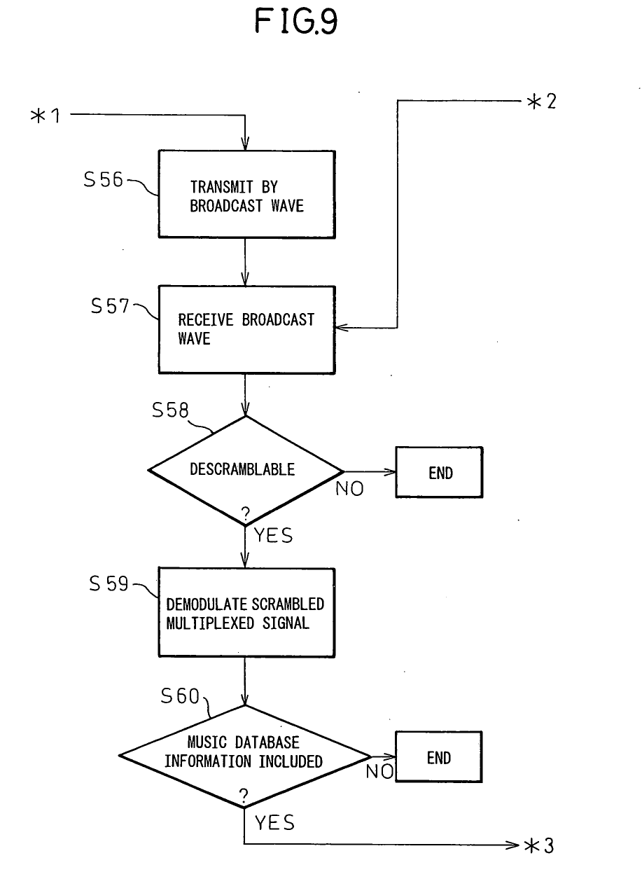

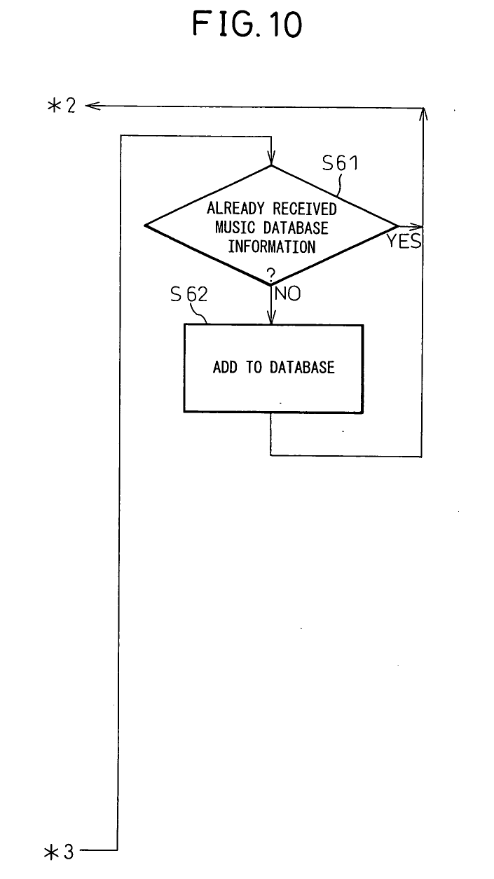

FIG. 8 is a flow chart of an example of operation of the updating system (part 1), FIG. 9 is the same flow chart (part 2), and FIG. 10 is the same flow chart (part 3).

First, referring to FIG. 8,

Step S51: The processes [1] and [2] of FIG. 5 are executed.

Step S52: The process [3] of FIG. 5 is executed.

Step S53: It is checked if the database (DB) information obtained at the above process [3] matches with the information requested at the process [2]. If OK, the routine proceeds to the next step.

Step S54: The process [4] of FIG. 5 is executed.

Step S55: The process [5] of FIG. 5 is executed to produce a multiplexed broadcast wave at the provider 25C. At this time, the above-mentioned scrambler is used to lock the multiplex signal. Next, referring to FIG. 9,

Step S56: the provider 25C transmits the multiplexed broadcast wave.

Step S57: The broadcast receiver 51 of the terminal 30 (FIG. 7) receives the multiplexed broadcast wave.

Step S58: Further, the signal is unlocked. This is performed by the above-mentioned descrambler.

Step S59: The transmission device 20 side demodulates the scrambled multiplexed signal and extracts the original database information.

Step S60: It is judged if the original database information includes a music database information. If it does, the routine proceeds to the next step (FIG. 10).

Step S61: As explained above, since the same music database information is for example repeatedly broadcast for a week, it is judged if the music database information has already been received. When the music database information has already been received, the broadcast wave starts to be received again (step S57). If the first time received, the routine proceeds to the next step.

Step S62: Since the music database information is the first received, this is added and stored in the reception side music database 31, whereupon the updating is ended. The routine then returns again to step S57 for restart of reception.

### INDUSTRIAL APPLICABILITY

The present invention can be applied to the case of realizing a system for updating a music database of a user side from an outside music database source through a broadcast wave.

1. An updating system of a music database provided with
a transmission apparatus having
a transmission use music database storing music database information comprising identification information for identifying recording media and music information corresponding to that identification information and
a broadcast function unit for broadcasting said music database information from said transmission use music database as multiplex information multiplexed on a broadcast wave and
a terminal including a reception function unit for receiving a broadcast wave on which the music database information is multiplexed broadcast from the broadcast function unit, an extraction function unit for extracting the music database information from the broadcast wave received by the reception function unit, and an update function unit for storing the music database information extracted by the extraction function unit in the reception side music database.

2. An updating system of music database as set forth in claim 1, wherein the transmission apparatus has a selection/collection function unit which cooperates with said transmission use music database and selects and collects the music database information to be stored there.

3. An updating system of a music database as set forth in claim 2, wherein the selection/collection function unit selects music database information based on various popularity ranking information from various music providers.

4. An updating system of a music database as set forth in claim 2, wherein the selection/collection function unit selects the music database information based on the frequency of broadcasts at various music providers or new music release information.

5. An updating system of a music database as set forth in claim 2, wherein the selection/collection function unit selects the music database information based on power play information generated among cooperating music providers or new music release information.

6. An updating system of a music database as set forth in any one of claims 2 to 5, wherein said transmission apparatus is provided with a database source continuously editing and registering new music to construct a general music database and wherein the selection/collection function unit collects the music database information from the database source.

7. An updating system of a music database as set forth in any one of claims 1 to 6, wherein the broadcast function unit transmits all of the music database information of the transmission use music database or the difference of the music database information newly added in the transmission use music database as multiplex information multiplexed on a predetermined broadcast wave.

8. An updating system of a music database as set forth in any one of claims 1 to 7, wherein the broadcast function unit transmits the music database information multiplexed on a predetermined broadcast wave repeatedly at all times or periodically at predetermined times.

9. An updating system of a music database as set forth in any one of claims 1 to 8, wherein the broadcast function unit is provided with a conversion function unit for converting the music database information to be transmitted to a format for multiplexing on a predetermined broadcast wave.

10. An updating system of a music database as set forth in any one of claims 1 to 8, wherein the reception function unit receives the multiplexed broadcast wave locked at the transmission apparatus side, unlocks the multiplexed broadcast wave by a key held by the terminal, and outputs the multiplexed broadcast wave to the music database information.

11. An updating system of a music database as set forth in any one of claims 1 to 9, wherein
the reception function unit receives the multiplexed broadcast wave with the music database information locked at the transmission apparatus side, and
the extraction function unit unlocks the music database information by a key held by the terminal to extract the music database information.

12. An updating system of a music database as set forth in claim 9, wherein the extraction function unit pulls out the music database information multiplexed on a predetermined broadcast wave by a predetermined format in accordance with that format.

13. An updating system of a music database as set forth in any one of claims 1 to 12, wherein when receiving all of the music database information from the transmission use music database of the transmission apparatus side, the update function unit rewrites the reception side music database with all that music database information received from the transmission use music database of the transmission apparatus side.

14. An updating system of a music database as set forth in any one of claims 1 to 12, wherein when receiving all of the music database information from the transmission side music database on the transmission apparatus side, the update function unit finds the unrecorded music database information from it and stores this in the reception side music database as the newly added difference in music database information.

15. An updating system of a music database as set forth in any one of claims 1 to 12, wherein when receiving the newly added and collected difference in music database information from the transmission use music database of the transmission apparatus side, the update function unit adds and stores the difference in music database information in the reception side music database.

16. An updating system of a music database as set forth in any one of claims 13 to 15, wherein the update function unit acquires once the music database information or difference in music database information broadcast repeatedly at all times or periodically at predetermined times from the transmission apparatus side, detects if the information is the same as the already received information, and, when not, stores it in the reception side music database.

17. An updating system of a music database as set forth in any one of claims 1 to 16, wherein the reception side music database enables a search for corresponding music information based on identification information of the recording media played.

18. A transmission apparatus of a music database including a transmission use music database storing music database information comprising identification information for identifying recording media and music information corresponding to that identification information and a broadcast function unit for broadcasting said music database information from said transmission use music database as multiplex information multiplexed on a broadcast wave.

19. A transmission apparatus of a music database as set forth in claim 18, further having a selection/collection function unit which cooperates with said transmission use music database and selects and collects the music database information to be stored there.

20. A transmission apparatus of a music database as set forth in claim 19, wherein the selection/collection function unit selects music database information based on various popularity ranking information from various music providers.

21. A transmission apparatus of a music database as set forth in claim 19, wherein the selection/collection function unit selects the music database information based on the frequency of broadcasts at various music providers or new music release information.

22. A transmission apparatus of a music database as set forth in claim 19, wherein the selection/collection function unit selects the music database information based on power play information generated among cooperating music providers or new music release information.

23. A transmission apparatus of a music database as set forth in any one of claims 19 to 22, wherein said apparatus is provided with a database source continuously editing and registering new music to construct a general music database, and the selection/collection function unit collects the music database information from the database source.

24. A transmission apparatus of a music database as set forth in any one of claims 18 to 23, wherein the broadcast function unit transmits all of the music database information of the transmission use music database or the difference of the music database information newly added in the transmission use music database as multiplex information multiplexed on a predetermined broadcast wave.

25. A transmission apparatus of a music database as set forth in any one of claims 18 to 24, wherein the broadcast function unit transmits the music database information multiplexed on a predetermined broadcast wave repeatedly at all times or periodically at predetermined times.

26. A transmission apparatus of a music database as set forth in any one of claims 18 to 24, wherein the broadcast function unit is provided with a conversion function unit for converting the music database information to be transmitted to a format for multiplexing on a predetermined broadcast wave.

27. A terminal having a function of updating a music database including:
a reception side music database enabling a search for corresponding music information based on identification information of the recording media to be played,
a reception function unit for receiving a broadcast wave on which the music database information broadcast from the broadcast function unit is multiplexed as multiplex information,
an extraction function unit for extracting the music database information from the broadcast wave received by the reception function unit, and
an update function unit for storing the music database information extracted by the extraction function unit in the reception side music database.

28. A terminal having a function of updating a music database as set forth in claim 27, wherein the reception function unit receives the multiplexed broadcast wave locked at the transmission apparatus side, unlocks the multiplexed broadcast wave by a key held by the terminal, and outputs the multiplexed broadcast wave to the music database information.

29. A terminal having a function of updating a music database as set forth in claim 27, wherein
the reception function unit receives the multiplexed broadcast wave with the music database information locked at the transmission apparatus side, and
the extraction function unit unlocks the music database information by a key held by the terminal to extract the music database information.

30. A terminal having a function of updating a music database as set forth in any one of claims 27 to 29, wherein the extraction function unit pulls out the music database information multiplexed on a predetermined broadcast wave by a predetermined format in accordance with that format.

31. A terminal having a function of updating a music database as set forth in any one of claims 27 to 30, wherein the update function unit rewrites the received music database information in the reception side music database or stores it in the reception side music database.

32. A terminal having a function of updating a music database as set forth in any one of claims 27 to 30, wherein the update function unit finds the unrecorded music database information from the received music database information and stores this in the reception side music database as the newly added difference in music database information.

33. A terminal having a function of updating a music database as set forth in claim 31 or 32, wherein the update function unit acquires once the music database information or difference in music database information broadcast repeatedly at all times or periodically at predetermined times from the transmission apparatus side, detects if the information is the same as the already received information, and, when not, stores it in the reception side music database.

34. An updating method of a music database provided with a transmission apparatus and terminal, comprising,
in said transmission apparatus,
a step of broadcasting music database information comprised of identification information identifying recording media stored in a transmission use music database and music information corresponding to said identification information as multiplex information multiplexed on a predetermined broadcast wave and,
at said terminal,
a step of receiving the predetermined broadcast wave on which said music database information has been multiplexed from said transmission apparatus,
a step of extracting the music database information from the received predetermined broadcast wave, and
a step of storing the extracted music database information in a reception side music database.

35. An updating method of a music database as set forth in claim 34, wherein the transmission apparatus has a selection/collection step of cooperating with said transmission use music database and selecting and collecting the music database information to be stored there.

36. An updating method of a music database as set forth in claim 35, wherein the selection/collection step selects music database information based on various popularity ranking information from various music providers.

37. An updating method of a music database as set forth in claim 35, wherein the selection/collection step selects the music database information based on the frequency of broadcasts at various music providers or new music release information.

38. An updating method of a music database as set forth in claim 35, wherein the selection/collection step selects the music database information based on power play information generated among cooperating music providers or new music release information.

39. An updating method of a music database as set forth in any one of claims 35 to 38, wherein the selection/collection step cooperates with a database source which continuously edits and registers new music to build a general music database.

40. An updating method of a music database as set forth in any one of claims 34 to 39, wherein the broadcast step transmits all of the music database information of the transmission use music database or the difference of the music database information newly added in the transmission use music database as multiplex information multiplexed on a predetermined broadcast wave.

41. An updating method of a music database as set forth in any one of claims 34 to 40, wherein the broadcast step transmits the music database information multiplexed on a predetermined broadcast wave repeatedly at all times or periodically at predetermined times.

42. An updating method of a music database as set forth in any one of claims 34 to 41, wherein the broadcast step is provided with a conversion function unit for converting the music database information to be transmitted to a format for multiplexing on a predetermined broadcast wave.

43. An updating method of a music database as set forth in any one of claims 34 to 42, wherein the reception step receives the multiplexed broadcast wave locked at the transmission apparatus side, unlocks the multiplexed broadcast wave by a key held by the terminal, and outputs the multiplexed broadcast wave to the music database information.

44. An updating method of a music database as set forth in any one of claims 34 to 42, wherein
the reception step receives the multiplexed broadcast wave with the music database information locked at the transmission apparatus side, and
the extraction step unlocks the music database information by a key held by the terminal to extract the music database information.

45. An updating step of a music database as set forth in claim 42, wherein the extraction step pulls out the music database information multiplexed on a predetermined broadcast wave by a predetermined format in accordance with that format.

46. An updating method of a music database as set forth in any one of claims 34 to 45, wherein when receiving all of the music database information from the transmission use music database of the transmission apparatus side, the update step rewrites the reception side music database with all that music database information received from the transmission use music database of the transmission apparatus side.

47. An updating method of a music database as set forth in any one of claims 34 to 45, wherein when receiving all of the music database information from the transmission side music database on the transmission apparatus side, the update step finds the unrecorded music database information from it and stores this in the reception side music database as the newly added difference in music database information.

48. An updating method of a music database as set forth in any one of claims 34 to 45, wherein when receiving the newly added and collected difference in music database information from the transmission use music database of the transmission apparatus side, the update step adds and stores the difference in music database information in the reception side music database.

49. An updating method of a music database as set forth in any one of claims 46 to 48, wherein the update step acquires once the music database information or difference in music database information broadcast repeatedly at all times or periodically at predetermined times from the transmission apparatus side, detects if the information is the same as the already received information, and, when not, stores it in the reception side music database.

50. An updating method of a music database as set forth in any one of claims 34 to 49, wherein the reception side music database enables a search for corresponding music information based on identification information of the recording media played.

51. A transmission method of a music database of a transmission apparatus transmitting music database information, including a step of broadcasting music database information comprising identification information for identifying recording media stored in a transmission use music database and music information corresponding to that identification information as multiplex information multiplexed on a predetermined broadcast wave.

52. A transmission method of a music database as set forth in claim 51, further having a selection/collection step of cooperating with said transmission use music database and selecting and collecting the music database information to be stored there.

53. A transmission method of a music database as set forth in claim 52, wherein the selection/collection step is performed based on various popularity ranking information from various music providers.

54. A transmission method of a music database as set forth in claim 52, wherein the selection/collection step is performed based on the frequency of broadcasts at various music providers or new music release information.

55. A transmission method of a music database as set forth in claim 52, wherein the selection/collection step is performed based on power play information generated among cooperating music providers or new music release information.

56. A transmission method of a music database as set forth in any one of claims 52 to 55, wherein the selection/collection step is performed in cooperation with a database source continuously editing and registering new music to construct a general music database.

57. A transmission method of a music database as set forth in any one of claims 51 to 56, wherein the broadcast step transmits all of the music database information of the transmission use music database or the difference of the music database information newly added in the transmission use music database as multiplex information multiplexed on a predetermined broadcast wave.

58. A transmission method of a music database as set forth in any one of claims 34 to 57, wherein the broadcast step transmits the music database information multiplexed on a predetermined broadcast wave repeatedly at all times or periodically at predetermined times.

59. A transmission method of a music database as set forth in any one of claims 51 to 58, wherein the broadcast step includes a conversion step of converting the music database information to be transmitted to a format for multiplexing on a predetermined broadcast wave.

60. An updating method of a music database of a terminal having a reception side music database enabling a search for corresponding music information based on identification information of recording media to be played, including
a step of receiving a predetermined broadcast wave on which the music database information is multiplexed,
a step of extracting the music database information from the received predetermined broadcast wave, and
a step of storing the extracted music database information in the reception side music database.

61. An updating method of a music database of a terminal as set forth in claim 60, wherein the reception step receives the multiplexed broadcast wave locked at the transmission side and unlocks the multiplexed broadcast wave by a key held by the terminal.

62. An updating method of a music database of a terminal as set forth in claim 60, wherein
the reception step receives the multiplexed broadcast wave with the music database information locked at the transmission apparatus side, and
the extraction step unlocks the music database information by a key held by the terminal to extract the music database information.

63. An updating method of a music database of a terminal as set forth in any one of claims 60 to 62, wherein the extraction step pulls out the music database information multiplexed on a predetermined broadcast wave by a predetermined format in accordance with that format.

64. An updating method of a music database of a terminal as set forth in any one of claims 60 to 63, wherein the update step rewrites the received music database information in the reception side music database or stores it in the reception side music database.

65. An updating method of a music database of a terminal as set forth in any one of claims 60 to 63, wherein the update step finds the unrecorded music database information from the received music database information and stores this in the reception side music database as the newly added difference in music database information.

66. An updating method of a music database of a terminal as set forth in claim 64 or 65, wherein the update step acquires once the music database information or difference in music database information broadcast repeatedly at all times or periodically at predetermined times from the transmission apparatus side, detects if the information is the same as the already received information, and, when not, stores it in the reception side music database.
